(19) United States
(12) Patent Application Publication
(10) Pub. No.: US 2012/0123632 A1
(43) Pub. Date: May 17, 2012

(54) Crash Verification And Notification Of Call Center Or Emergency Responders

(75) Inventor: Allen Nejah, San Jose, CA (US)

(73) Assignee: SUNMAN ENGINEERING, INC., San Jose, CA (US)

(21) Appl. No.: 12/948,698

(22) Filed: Nov. 17, 2010

(51) Int. Cl. G06F 7/00

(52) U.S. Cl. 701/32.2

(57) ABSTRACT

A method is provided for an aftermarket device to provide telematics service for a vehicle. The method includes accessing sensor data internal to the device and on-board diagnostic data from the vehicle, determining if one or more combinations of the sensor data and the on-board diagnostic data indicate a crash of the vehicle, and wirelessly contacting a call center or an emergency responder when at least one combination of the sensor data and the on-board diagnostic data indicates a crash of the vehicle.

### FIELD OF INVENTION

This invention relates to a method for verifying a vehicle has crashed and notifying a call center or emergency responders.

### DESCRIPTION OF RELATED ART

OnStar®, a wholly owned subsidiary of GM®, is a leading provider of telematics services. An OnStar® module connects an on-board vehicle computer to the OnStar® Center via cellular communications. A GM® vehicle is equipped with multiple built-in sensors, which allows the vehicle computer to capture critical real-time details in the event of a crash. The OnStar® module can provide the details to an advisor at the OnStar® Center, who can alert and pass along critical information to emergency responders. Other car manufacturers offer similar telematics systems and services. It is difficult for an independent party to offer aftermarket telematics systems and services as the telematics module needs to be intimately tied to the vehicle computer, which is often proprietary.

### SUMMARY

In one or more embodiments of the present disclosure, a method is provided for an aftermarket device to provide telematics service for a vehicle. The method includes accessing sensor data internal to the device and on-board diagnostic data from the vehicle, determining if one or more combinations of the sensor data and the on-board diagnostic data indicate a crash of the vehicle, and wirelessly contacting a call center or an emergency responder when at least one combination of the sensor data and the on-board diagnostic data indicates a crash of the vehicle.

### BRIEF DESCRIPTION OF THE DRAWINGS

In the drawings:

FIG. 1A illustrates an in-dash version of an aftermarket device that provides telematics service in one or more embodiments of the present disclosure;

FIG. 1B illustrates a portable version of the aftermarket device that provides telematics service in one or more embodiments of the present disclosure;

FIG. 2 is a block diagram of the device of FIG. 1A or 1B in one or more embodiments of the present disclosure; and

FIG. 3 is a flowchart of a method for the device of FIG. 1A or 1B to determine a crash and notify a call center or emergency responders in one or more embodiments of the present disclosure.

FIG. 4 is a block diagram of an automobile bus interface of the device of FIG. 2 in one or more embodiment of the present disclosure.

Use of the same reference numbers in different figures indicates similar or identical elements.

### DETAILED DESCRIPTION

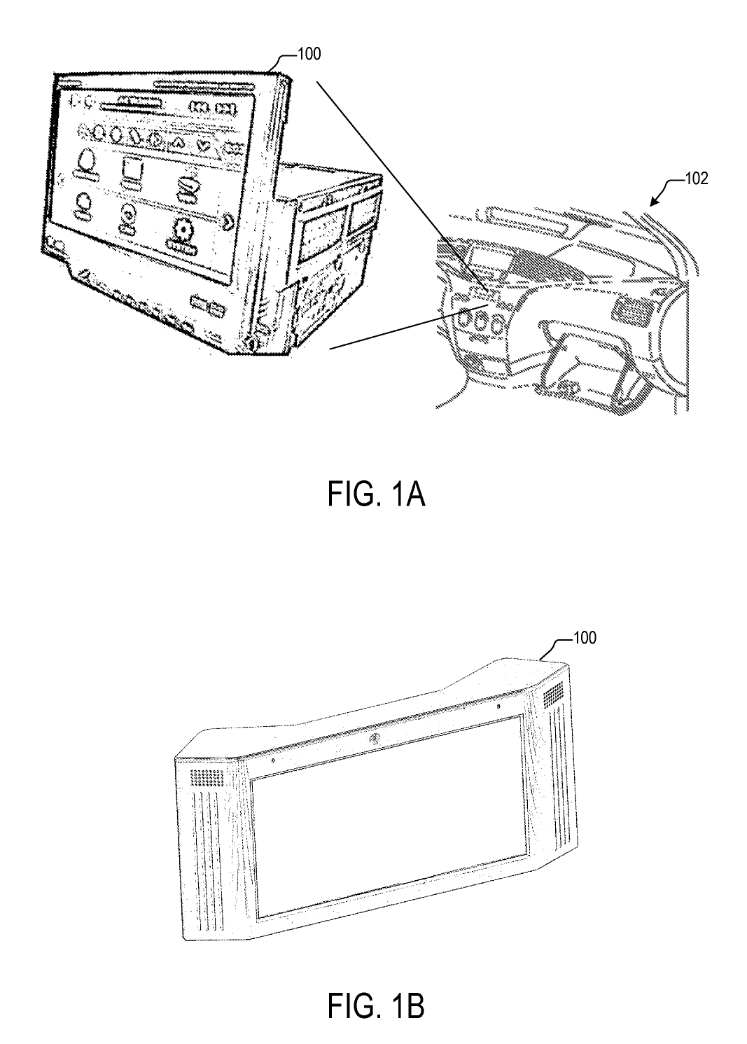

FIG. 1A illustrates an in-dash version of aftermarket device 100 that provides telematics services for a vehicle 102 in one or more embodiments of the present disclosure. Vehicle 102 may be a car, a motorcycle, a boat, or any other vehicle. Device 100 may be a detachable head unit received in the dash of vehicle 102. FIG. 1B illustrates a portable version of aftermarket device 100 that the user can carry in and out of the vehicle, similar to a global positioning satellite (GPS) receiver, in one or more embodiment of the present disclosure.

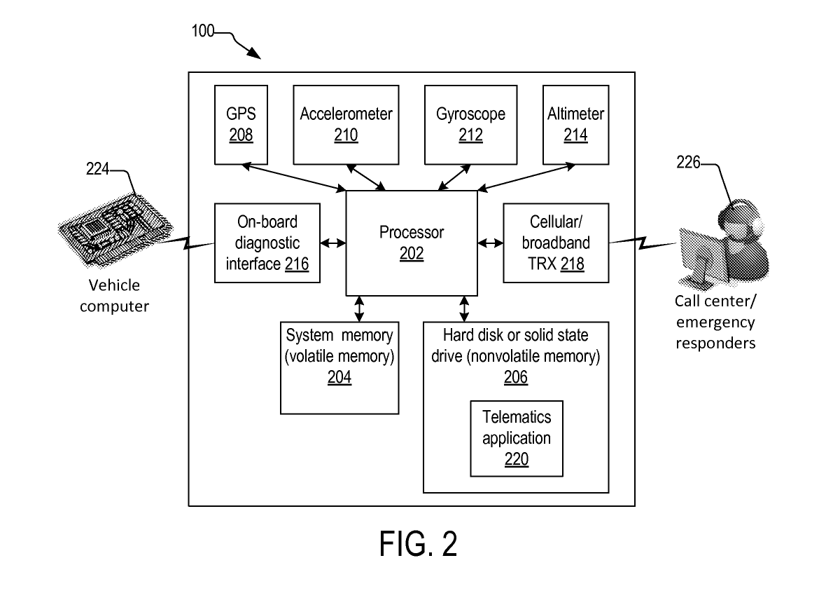

FIG. 2 is a block diagram of device 100 of FIG. 1A or 1B in one or more embodiments of the present disclosure. Device 100 includes a processor 202, system memory (volatile memory) 204, a hard disk or solid state drive (nonvolatile memory) 206, a GPS receiver 208, an accelerometer 210, a gyroscope 212, an altimeter 214, an on-board diagnostics (OBD) interface 216 (e.g., OBD-II), and a cellular or broadband transceiver 218. Hard disk drive 206 stores a telematics application 220, which is loaded into system memory 204 and executed by processor 202.

Executing telematics application 220, processor 202 monitors sensor data from within device 100 and OBD-II data from vehicle 102 to determine if a crash has occurred. Processor 202 has access to acceleration data from accelerometer 210, orientation data from gyroscope 212, and altitude data altimeter 214. Processor 202 uses OBD-II interface 216 to access OBD-II data from an on-board vehicle computer 224 of vehicle 102. The OBD-II data include vehicle speed data and engine revolution per minute (RPM) data. OBD-II interface 216 makes either a wired or a wireless connection to the vehicle computer.

When a crash is detected, processor 202 uses transceiver 218 provide relevant information to a call center 226, and an advisor contacts emergency responders for assistance. Instead of contacting a call center, processor 202 can directly contact the emergency responders 226. The relevant information describes the vehicle's route, including the vehicle's current location, the vehicle's orientation along the route, which may indicate any rollover, and the severity of the crash. In other words, device 100 acts similar to a flight data recorder or “black box” for an aircraft. Processor 202 determines the vehicle's route using GPS receiver 208. Processor 202 determines the vehicle's orientation from gyroscope 212. Processor 202 determines the severity of the crash from a combination of the sensor data and the OBD-II data. Processor 202 records the vehicle's route, the vehicle's orientation, and the severity of the crash in hard disk or solid state drive 206.

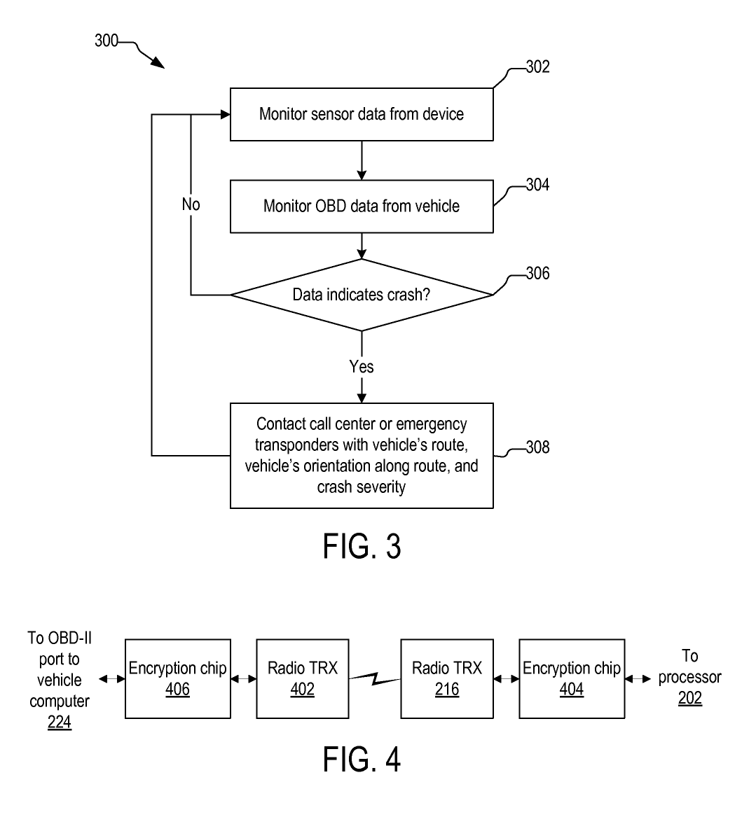

FIG. 3 is a flowchart of a method 300 for device 100 of FIG. 1A or 1B to detect a crash and alert a call center or emergency responders in one or more embodiments of the present disclosure. Method 300 may be implemented by processor 202 executing telematics application 220. Although the blocks are illustrated in a sequential order, these blocks may also be performed in parallel, and/or in a different order than those described herein. Also, the various blocks may be combined into fewer blocks, divided into additional blocks, and/or eliminated based upon the desired implementation. Method 300 may begin in block 302.

In block 302, processor 202 monitors the sensor data from within device 100, such as sensor data from accelerometer 210, gyroscope 212, and altimeter 214. Block 302 may be followed by block 304.

In block 304, processor 202 monitors the OBD-II data from vehicle computer 224. Note that processor 202 may monitor the sensor data and the OBD-II data concurrently. Block 304 may be followed by block 306.

In decision block 306, processor 202 determines if a combination of the sensor data and the OBD-II data indicates a crash of vehicle 102. The combination may include one or more of a rapid deceleration, a rapid change in direction or orientation, a rapid change in altitude, a rapid decrease in speed, and a rapid decrease in engine RPM indicate a crash. When a combination of the sensor data and the OBD-II data indicates a crash, decision block 306 may be followed by block 308. Otherwise decision block 306 loops back to block 302.

In block 308, processor 202 uses transceiver 218 to contact a call center or emergency responder 226. In the communications, processor 202 provides the vehicle's route, including the vehicle's current location, the vehicle's orientation along the route, and the severity of the crash. Block 308 may loop back to block 302.

FIG. 4 is a block diagram of OBD-II interface 216 in device 100 of FIG. 2 in one or more embodiment of the present disclosure. In this embodiment, OBD-II interface 216 is implemented as a radio transceiver, and another radio transceiver 402 is coupled the OBD-II port to vehicle computer 224 for wireless communication between device 100 and vehicle computer 224. In one embodiment, the data may be encrypted and decrypted at both ends by encryption devices 404 and 406 before reaching radio transceivers 216 and 402, respectively. Radio transceivers 216 and 402 may be Bluetooth transceivers. Instead of encryption device 404, processor 202 may perform the encryption.

Various other adaptations and combinations of features of the embodiments disclosed are within the scope of the present disclosure. Numerous embodiments are encompassed by the following claims.

What is claimed is:

1: A method for an aftermarket device to provide telematics service for a vehicle, comprising:
monitoring sensor data from sensors internal to the device;
monitoring on-board diagnostic data from the vehicle;
determining if one or more combinations of the sensor data and the on-board diagnostic data indicate a crash of the vehicle; and
when at least one combination of the sensor data and the on-board diagnostic data indicates a crash of the vehicle, wirelessly contacting a call center or an emergency responder.

2: The method of claim 1, wherein:
the sensor data includes at least one of acceleration data, orientation data, and altitude data; and
at least one of a rapid deceleration, a rapid change in orientation, and a rapid change in altitude is part of a combination that indicates a crash of the vehicle.

3: The method of claim 1, wherein:
the on-board diagnostic data includes at least one of vehicle speed and engine revolution per minute; and
a rapid decrease in at least one of the vehicle speed and the engine revolution per minute is part of a combination that indicates a crash of the vehicle.

4: The method of claim 1, wherein wirelessly contacting a call center or an emergency responder comprises:
sending a route of the vehicle and an orientation of the vehicle along the route.

5: The method of claim 1, wherein wirelessly contacting a call center or an emergency responder comprises:
sending a severity of the crash.

6: The method of claim 1, wherein said monitoring the on-board diagnostic data comprises wirelessly accessing the on-board diagnostic data from the vehicle.

7: The method of claim 6, wherein said wirelessly accessing the on-board diagnostic data comprises using encrypted communications.

8: A aftermarket device for a vehicle, comprising:
one or more sensors;
an on-board diagnostic interface;
a transceiver;
a processor;
a non-transitory, computer-readable medium storing executable instructions for the processor, the executable instructions comprising:
monitoring sensor data from sensors internal to the device;
monitoring on-board diagnostic data from the vehicle;
determining if one or more combinations of the sensor data and the on-board diagnostic data indicate a crash of the vehicle; and
when at least one combination of the sensor data and the on-board diagnostic data indicates a crash of the vehicle, wirelessly contacting a call center or an emergency responder.

9: The device of claim 8, wherein:
the one or more sensors comprises one or more of an accelerometer, a gyroscope, and an altimeter; and
at least one of a rapid deceleration, a rapid change in orientation, and a rapid change in altitude is part of a combination that indicates a crash of the vehicle.

10: The device of claim 8, wherein:
the on-board diagnostic data includes at least one of vehicle speed and engine revolution per minute; and
a rapid decrease in at least one of the vehicle speed and the engine revolution per minute is part of a combination that indicates a crash of the vehicle.

11: The device of claim 8, further comprising a global positioning satellite receiver, wherein wirelessly contacting a call center or an emergency responder comprises sending a route of the vehicle and an orientation of the vehicle along the route.

12: The device of claim 10, wherein wirelessly contacting a call center or an emergency responder comprises sending a severity of the crash.

13: The device of claim 10, wherein on-board diagnostic interface comprises a first radio transceiver wirelessly communicating a second radio transceiver coupled to an on-board diagnostic port of the vehicle.

14: The device of claim 13, further comprising an encryption device coupled to the first radio transceiver.

15: The device of claim 14, wherein the second radio transceiver is coupled to another encryption device for encrypted communication between the first and the second radio transceivers.
